(19) United States
(12) Patent Application Publication
(10) Pub. No.: US 2020/0284189 A1
(43) Pub. Date: Sep. 10, 2020

(54) PROCESS FOR REGULATING FLOWS IN OPERATION OF A POWER GENERATION PLANT

(71) Applicant: 8 RIVERS CAPITAL, LLC, Durham, NC (US)

(72) Inventors: Yasunori IWAI, Yokohama-shi (JP); Masao ITOH, Yokohama-shi (JP); Shinju SUZUKI, Yokohama-shi (JP); Yuichi MORISAWA, Yokohama-shi (JP); Jeremy Eron Fetvedt, Raleigh, NC (US); Rodney John Allam, Chippenham (GB)

(21) Appl. No.: 16/825,888

(22) Filed: Mar. 20, 2020

Related U.S. Application Data
(63) Continuation of application No. 14/331,361, filed on Jul. 15, 2014.

(30) Foreign Application Priority Data
Jul. 22, 2013 (JP) 2013-151790

(51) Int. Cl. F02C 3/34; F02C 7/057

(52) U.S. Cl. CPC F02C 3/34; Y02E 20/16; F02C 7/057

(57) ABSTRACT

A gas turbine facility 10 of an embodiment has a combustor 20 combusting fuel and oxidant, a turbine 21 rotated by combustion gas exhausted from the combustor 20, and a pipe 41 guiding a part of the combustion gas exhausted from the turbine 21 to a pipe 42 supplying the oxidant. Further, the gas turbine facility 10 has a pipe 43 guiding mixed gas constituted of the oxidant and the combustion gas to the combustor 20, a pipe 45 guiding another part of the combustion gas to the combustor 20 as working fluid of the turbine, and a pipe 40 exhausting a remaining part of the combustion gas to an outside.

### CROSS-REFERENCE TO RELATED APPLICATION

This application is based upon and claims the benefit of priority from Japanese Patent Application No. 2013-151790, filed on Jul. 22, 2013; the entire contents of which are incorporated herein by reference.

### FIELD

Embodiments described herein relate generally to a gas turbine facility.

### BACKGROUND

Increasing efficiency of power generation plants is in progress in response to demands for reduction of carbon dioxide, resource conservation, and the like. Specifically, increasing temperature of working fluid of a gas turbine and a steam turbine, employing a combined cycle, and the like are actively in progress. Further, research and development of collection techniques of carbon dioxide are in progress.

FIG. 5 is a system diagram of a conventional gas turbine facility in which a part of carbon dioxide generated in a combustor is circulated as working fluid. As illustrated in FIG. 5, oxygen separated from an air separator (not illustrated) is compressed by a compressor 310, and its flow rate is controlled by a flow rate regulating valve 311. The oxygen which has passed through the flow rate regulating valve 311 is heated by receiving a heat quantity from combustion gas in the heat exchanger 312, and is supplied to a combustor 313.

Fuel is regulated in flow rate by a flow rate regulating valve 314 and is supplied to the combustor 313. This fuel is hydrocarbon. The fuel and oxygen react (combust) in the combustor 313. When the fuel combusts with oxygen, carbon dioxide and water vapor are generated as combustion gas. The flow rates of fuel and oxygen are regulated to be of a stoichiometric mixture ratio in a state that they are completely mixed.

The combustion gas generated in the combustor 313 is introduced into a turbine 315. The combustion gas which performed an expansion work in the turbine 315 passes through the heat exchanger 312 and then further through a heat exchanger 316. When passing through the heat exchanger 316, the water vapor condenses into water. The water passes through a pipe 319 and is discharged to the outside.

The carbon dioxide separated from the water vapor is compressed by a compressor 317. A part of the compressed carbon dioxide is regulated in flow rate by a flow rate regulating valve 318 and is exhausted to the outside. The rest of the carbon dioxide is heated in the heat exchanger 312 and supplied to the combustor 313.

Now, the carbon dioxide supplied to the combustor 313 is used to cool wall surfaces of the combustor 313 and dilute the combustion gas. Then, the carbon dioxide is introduced into the combustor 313 and introduced into the turbine 315 together with the combustion gas.

In the system, the carbon dioxide and water generated by the hydrocarbon and oxygen supplied to the combustor 313 are exhausted to the outside of the system. Then, the remaining carbon dioxide circulates through the system.

In the conventional gas turbine facility, oxygen is compressed to a high pressure by the compressor 310, and is further heated to a high temperature by passing through the heat exchanger 312. When the concentration of oxygen is high and the temperature of oxygen is high, it may facilitate metal oxidation of supply pipes of oxidant.

Further, as described above, since the flow rates of fuel and oxygen are regulated to be of a stoichiometric mixture ratio in a state that they are completely mixed, the temperature of the combustion gas is at high temperature. Accordingly, the carbon dioxide generated by combustion is thermally dissociated and becomes an equilibrium state at a certain concentration with the carbon monoxide. The higher the temperature of the combustion gas, the higher the concentration of carbon monoxide.

When the carbon dioxide compressed by the compressor 317 is introduced into an area where the concentration of this carbon monoxide is high, the combustion temperature decreases. Thus, there occurs a problem that carbon monoxide is exhausted from the combustor 313 without being oxidized.

### BRIEF DESCRIPTION OF THE DRAWINGS

FIG. 1 is a system diagram of a gas turbine facility of an embodiment.

FIG. 2 is a diagram illustrating a maximum combustion gas temperature relative to an equivalence ratio when a mass ratio of oxygen to mixed gas is changed.

FIG. 3 is a diagram illustrating a concentration of carbon monoxide relative to the equivalence ratio when the mass ratio of oxygen to the mixed gas is changed.

FIG. 4 is a diagram illustrating a stable combustion area based on the mass ratio of oxygen to the mixed gas and the maximum combustion gas temperature.

FIG. 5 is a system diagram of a conventional gas turbine facility in which a part of carbon dioxide generated in a combustor is circulated as working fluid.

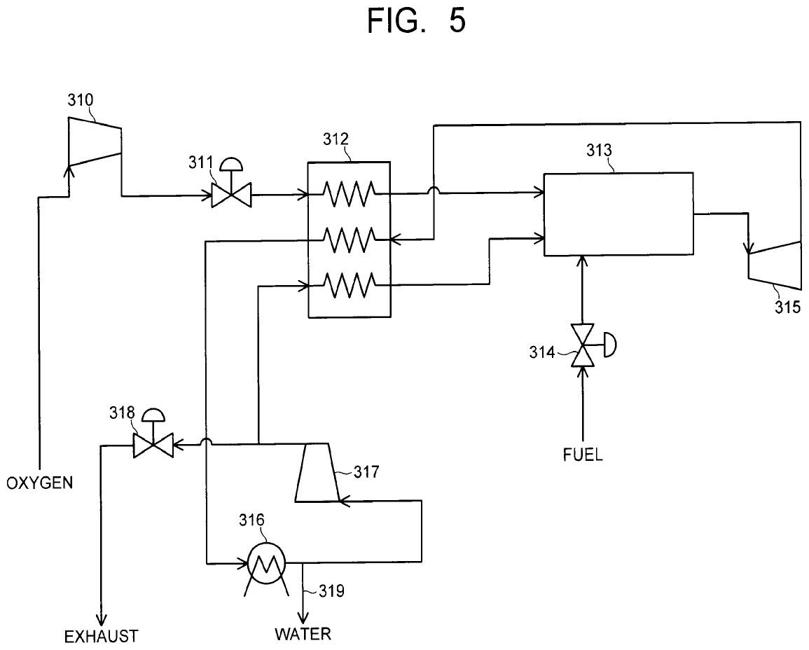

### DETAILED DESCRIPTION

In one embodiment, a gas turbine facility has a combustor combusting fuel and oxidant, a turbine rotated by combustion gas exhausted from the combustor, and a combustion gas supply pipe guiding a part of the combustion gas exhausted from the turbine to an oxidant supply pipe supplying the oxidant. Further, the gas turbine facility has a mixed gas supply pipe guiding mixed gas constituted of the oxidant and the combustion gas to the combustor, a working fluid supply pipe guiding another part of the combustion gas to the combustor as working fluid of the turbine, and an exhaust pipe exhausting a remaining part of the combustion gas to an outside.

Hereinafter, embodiments will be described with reference to drawings.

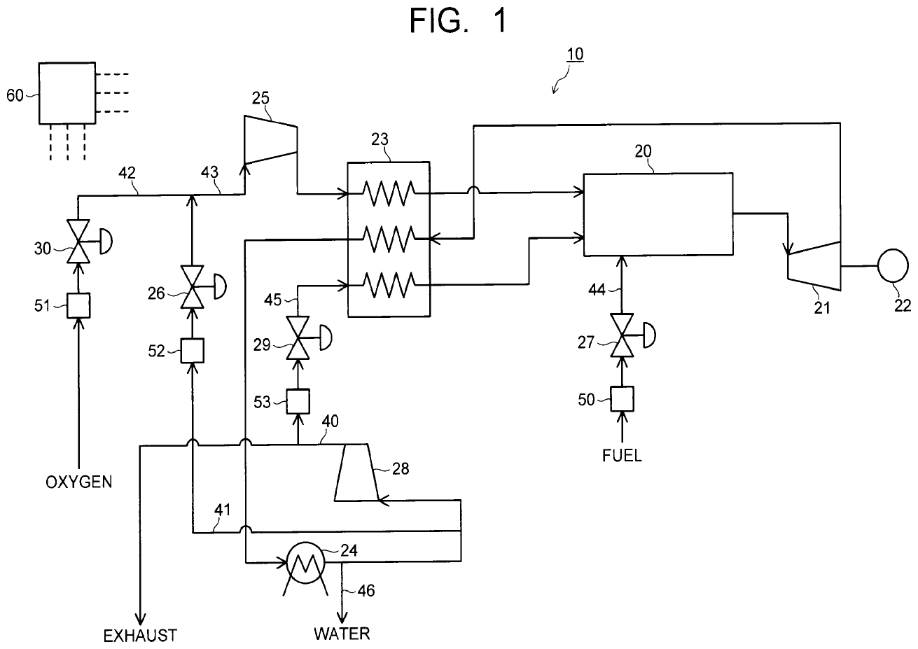

FIG. 1 is a system diagram of a gas turbine facility 10 of an embodiment. As illustrated in FIG. 1, the gas turbine facility 10 has a combustor 20 combusting fuel and oxidant and a turbine 21 rotated by combustion gas exhausted from this combustor 20. For example, a generator 22 is coupled to this turbine 21. Note that the combustion gas mentioned here exhausted from the combustor 20 contains combustion product, generated by fuel and oxidant, and dry combustion gas (carbon dioxide), which will be described later, supplied to the combustor 20 and exhausted together with the combustion product from the combustor 20.

The combustion gas exhausted from the turbine 21 is cooled by passing through a heat exchanger 23. The combustion gas which passed through the heat exchanger 23 further passes through a heat exchanger 24. By passing through the heat exchanger 24, water vapor contained in the combustion gas is removed, and thereby the combustion gas becomes dry combustion gas. Here, by passing through the heat exchanger 24, the water vapor condenses into water. The water passes through a pipe 46 for example and is discharged to the outside.

A part of the dry combustion gas flows into a pipe 41 branched from a pipe 40 in which dry combustion gas flows. Then, a part of the dry combustion gas is regulated in flow rate by a flow rate regulating valve 26 interposed in the pipe 41, and is guided into a pipe 42 supplying oxidant. In the pipe 42, oxygen separated from the atmosphere by an air separator (not illustrated) flows as oxidant. A flow rate regulating valve 30 regulating a flow rate of oxidant is interposed in the pipe 42.

Note that the pipe 41 functions as a combustion gas supply pipe, and the pipe 42 as an oxidant supply pipe. Further, the flow rate regulating valve 26 functions as a combustion gas flow rate regulating valve, and the flow rate regulating valve 30 as an oxidant flow rate regulating valve.

Here, for example, hydrocarbon is used as the fuel, and when the flow rates of fuel and oxygen are regulated to be of a stoichiometric mixture ratio (equivalence ratio 1) and combusted in the combustor 20, components of the dry combustion gas are mostly carbon dioxide. Note that the dry combustion gas also includes the case where, for example, a minute amount of carbon monoxide of 0.2% or less is mixed in. As the hydrocarbon, for example, natural gas, methane, or the like is used. Further, coal gasification gas can also be used as the fuel.

Mixed gas constituted of oxidant and dry combustion gas flows through a pipe 43 and is compressed by a compressor 25 interposed in the pipe 43. The compressed mixed gas passes through the heat exchanger 23 and is guided to the combustor 20. Note that the pipe 43 functions as a mixed gas supply pipe.

The mixed gas obtains in the heat exchanger 23 a heat quantity from combustion gas exhausted from the turbine 21 and is heated thereby. The mixed gas guided to the combustor 20 is introduced into a combustion area together with fuel supplied from the pipe 44. Then, the oxidant of the mixed gas and fuel occur a combustion reaction to generate combustion gas. Note that a flow rate regulating valve 27 regulating the flow rate of fuel supplied to the combustor 20 is interposed in the pipe 44.

On the other hand, a compressor 28 is interposed in the pipe 40 on a downstream side of a position where the pipe 41 branches. In the dry combustion gas, the dry combustion gas other than that diverged to the pipe 41 is compressed by the compressor 28. A part of the compressed dry combustion gas flows into a pipe 45 branched from the pipe 40. Then, the dry combustion gas flowing through the pipe 45 is regulated in flow rate by a flow rate regulating valve 29 interposed in the pipe 45 and is guided to the combustor 20 via the heat exchanger 23. Note that the pipe 45 functions as a working fluid supply pipe, and the flow rate regulating valve 29 as a working fluid flow rate regulating valve.

The dry combustion gas flowing through the pipe 45 obtains in the heat exchanger 23 a heat quantity from the combustion gas exhausted from the turbine 21 and is heated thereby. The dry combustion gas guided to the combustor 20 cools, for example, a combustor liner, and is introduced to a downstream side of a combustion area in the combustor liner via a dilution hole or the like. This dry combustion gas rotates the turbine 21 together with the combustion gas generated by combustion, and hence functions as working fluid.

On the other hand, a remaining part of the dry combustion gas compressed by the compressor 28 is exhausted to the outside from an end of the pipe 40. The end of the pipe 40 exhausting the dry combustion gas to the outside also functions as an exhaust pipe.

The gas turbine facility 10 has a flow rate detecting unit 50 detecting the flow rate of fuel flowing through the pipe 44, a flow rate detecting unit 51 detecting the flow rate of oxidant flowing through the pipe 42, a flow rate detecting unit 52 detecting the flow rate of dry combustion gas flowing through the pipe 41, and a flow rate detecting unit 53 detecting the flow rate of dry combustion gas (working fluid) flowing through the pipe 45. Each flow rate detecting unit is constituted of, for example, a flowmeter of venturi type, Coriolis type, or the like.

Here, the flow rate detecting unit 50 functions as a fuel flow rate detecting unit, the flow rate detecting unit 51 functions as an oxidant flow rate detecting unit, the flow rate detecting unit 52 functions as a combustion gas flow rate detecting unit, and the flow rate detecting unit 53 functions as a working fluid flow rate detecting unit.

The gas turbine facility 10 has a control unit 60 which controls openings of the respective flow rate regulating valves 26, 27, 29, 30 based on detection signals from the respective flow rate detecting units 50, 51, 52, 53. This control unit 60 mainly has, for example, an arithmetic unit (CPU), a storage unit such as a read only memory (ROM) and a random access memory (RAM), an input/output unit, and so on. The CPU executes various arithmetic operations using, for example, programs, data, and the like stored in the storage unit.

The input/output unit inputs an electrical signal from an outside device or outputs an electrical signal to an outside device. Specifically, the input/output unit is connected to, for example, the respective flow rate detecting units 50, 51, 52, 53 and the respective flow rate regulating valves 26, 27, 29, 30, and so on in a manner capable of inputting/outputting various signals. Processing executed by this control unit 60 is realized by, for example, a computer apparatus or the like.

Here, in the mixed gas flowing through the pipe 43, preferably, the ratio of oxidant to the mixed gas is 15 to 40 mass %. Further, more preferably, the ratio of oxidant to the mixed gas is 20 to 30 mass %. Note that the mixed gas is constituted of the dry combustion gas (carbon dioxide) and oxidant (oxygen).

Hereinafter, reasons for that the ratio of oxidant (oxygen) to the mixed gas in the above range is preferred will be described.

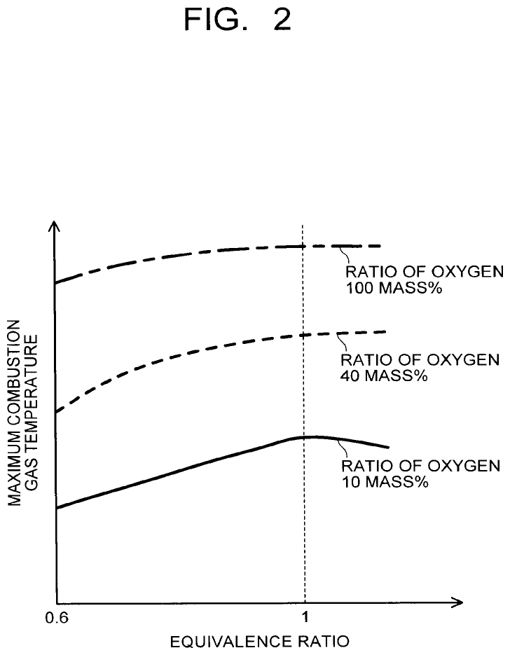

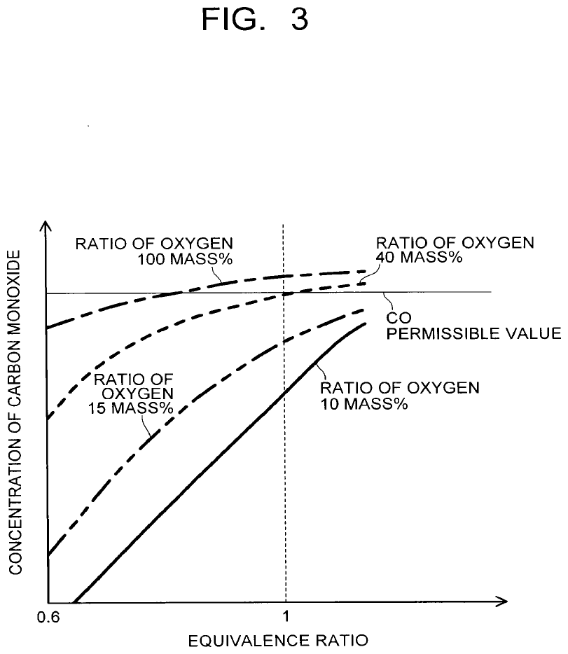

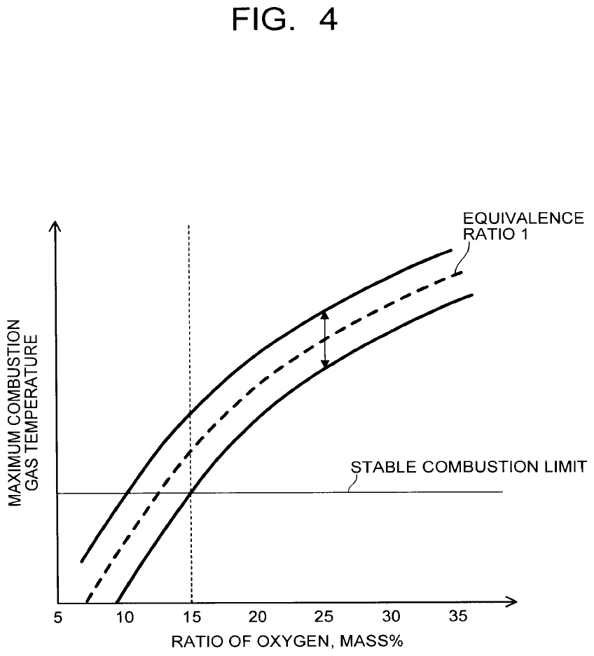

FIG. 2 is a diagram illustrating a maximum combustion gas temperature relative to an equivalence ratio when a mass ratio of oxygen to the mixed gas is changed. In FIG. 2, the maximum combustion gas temperature is an adiabatic flame temperature. FIG. 3 is a diagram illustrating a concentration of carbon monoxide relative to an equivalence ratio when the mass ratio of oxygen to the mixed gas is changed. In FIG. 3, the concentration of carbon monoxide, that is, the vertical axis is expressed by a logarithm. Further, the concentration of carbon monoxide is an equilibrium composition value in adiabatic flame temperatures of respective conditions. FIG. 4 is a diagram illustrating a stable combustion area based on the mass ratio of oxygen to the mixed gas and the maximum combustion gas temperature. In FIG. 4, a set equivalence ratio is 1, and a variation width in normal operation of the set equivalence ratio due to a flow rate variation or the like is expressed with a solid line. Further, in FIG. 4, the stable combustion area is an area where it becomes the maximum combustion gas temperature or more in the stable combustion limit.

Note that FIG. 2 to FIG. 4 are examples calculated using methane (CH₄) as fuel. Further, the equivalence ratio in FIG. 2 and FIG. 3 is an equivalence ratio assuming that fuel and oxygen are mixed homogeneously.

As illustrated in FIG. 2, the maximum combustion gas temperature increases as the ratio of oxygen increases. For example, when compared with the same equivalence ratio, the flow rates of fuel, oxygen, and carbon dioxide supplied to the combustor 20 are the same. Accordingly, a difference in oxygen concentration means a difference in flow rate of dry combustion gas (carbon dioxide) to be mixed with oxygen.

For example, when the ratio of oxygen is small, the flow rate of dry combustion gas to be mixed is large. Accordingly, the flow rate of dry combustion gas (working fluid) which flows into the combustor 20 via the pipe 45 decreases. On the other hand, when the ratio of oxygen is large, the flow rate of mixed dry combustion gas is small. Accordingly, the flow rate of dry combustion gas (working fluid) which flows into the combustor 20 via the pipe 45 increases. That is, it can be seen that, when the ratio of oxygen in the mixed gas to be injected into the combustion area together with fuel differs, the maximum combustion gas temperature (adiabatic flame temperature) in the combustion area differs largely even when the temperature of combustion gas at the exit of the combustor 20 is the same.

As illustrated in FIG. 3, as the ratio of oxygen increases, the concentration of carbon monoxide increases. This is because, as the ratio of oxygen increases, the flame temperature increases and the equilibrium composition value of carbon monoxide in the combustion area increases. In order to decrease the concentration of carbon monoxide to a permissible value or less, the ratio of oxygen needs to be 40 mass % or less. From a viewpoint of further decreasing the concentration of carbon monoxide, more preferably, the ratio of oxygen is 30 mass % or less. Note that the permissible value of the concentration of carbon monoxide is set to, for example, a concentration by which predetermined combustion efficiency or more can be obtained.

By making the ratio of oxygen be 40 mass % or less, the concentration of carbon monoxide contained in the combustion gas can be decreased even when, for example, oxidation of carbon monoxide is not facilitated by the dry combustion gas introduced into a downstream side of the combustion area in the combustor liner from the dilution hole or the like.

In order to maintain stable combustion in the combustion area, it is necessary to set the maximum combustion gas temperature to be equal to or more than a temperature to be the stable combustion limit. As illustrated in FIG. 4, the set equivalence ratio is 1, and when the variation width is considered, the ratio of oxygen needs to be 15 mass % or more. In order to obtain more stable combustion, more preferably, the ratio of oxygen is 20 mass % or more.

Here, the stable combustion limit is set based on, for example, the maximum combustion gas temperature at which a flame holding property of flame worsens, or the blow-off of flame occurs.

From results illustrated in FIG. 2 to FIG. 3, in order to decrease the concentration of carbon monoxide while maintaining stable combustion, preferably, the ratio of oxidant to the mixed gas is 15 to 40 mass %. Further, more preferably, the ratio of oxidant to the mixed gas is 20 to 30 mass %.

Further, in the pipe 43, it is possible to suppress oxidation of pipes more by mixing and providing the dry combustion gas (carbon dioxide) than by providing pure oxygen.

Here, when the piping is structured such that, for example, the dry combustion gas before passing through the heat exchanger 23 is mixed with the oxidant which passed through the heat exchanger 23, low-temperature fluid is blown into high-temperature fluid. Thus, heat stress may occur in the pipe of the mixing part. Further, when the piping is structured such that, for example, the pipe 45 is branched and the dry combustion gas which passed through the heat exchanger 23 is mixed into the oxidant which passed through the heat exchanger 23, it is necessary to provide a flow rate regulating valve in the branch pipe. However, since the high-temperature dry combustion gas flows through the branch pipe, it is necessary to use a valve for high temperature, which increases facility costs.

Accordingly, as illustrated in FIG. 1, by structuring the piping such that the position to mix oxidant and dry combustion gas is on the upstream side of the heat exchanger 23, the occurrence of excessive stress in the pipe of the mixing part and the increase in facility costs can be prevented.

Next, operations related to flow rate regulation of the mixed gas constituted of oxygen and dry combustion gas (carbon dioxide), the fuel, and the dry combustion gas (carbon dioxide) as the working fluid to be supplied to the combustor 20 will be described with reference to FIG. 1.

While the gas turbine facility 10 is operated, an output signal from the flow rate detecting unit 50 is inputted to the control unit 60 via the input/output unit. Based on the inputted output signal, the oxygen flow rate needed for making the equivalence ratio be 1 is calculated in the arithmetic unit by using programs, data, and so on stored in the storage unit. Note that the fuel flow rate is controlled by regulating an opening of the flow rate regulating valve 27 based on, for example, a required gas turbine output.

Here, in the gas turbine facility 10, it is preferred that no excess oxidant (oxygen) and fuel remain in the combustion gas exhausted from the combustor 20. Accordingly, the flow rates of fuel and oxygen supplied to the combustor 20 are regulated to be of a stoichiometric mixture ratio (equivalence ratio 1).

Subsequently, based on an output signal from the flow rate detecting unit 51 which is inputted from the input/output unit, the control unit 60 outputs an output signal for regulating the valve opening from the input/output unit to the flow rate regulating valve 30 so that the calculated oxygen flow rate flows through the pipe 42.

Next, in the arithmetic unit of the control unit 60, based on an output signal from the flow rate detecting unit 51 which is inputted from the input/output unit, the flow rate of dry combustion gas (carbon dioxide) mixed with oxygen is calculated so that the ratio of oxidant to the mixed gas becomes the set value. Here, the set value is set to be 15 to 40 mass % as described above.

Subsequently, based on an output signal from the flow rate detecting unit 52 which is inputted from the input/output unit, the control unit 60 outputs an output signal for regulating the valve opening from the input/output unit to the flow rate regulating valve 26 so that the calculated carbon dioxide flow rate flows through the pipe 41.

Next, in the arithmetic unit of the control unit 60, based on output signals from the flow rate detecting unit 50 and the flow rate detecting unit 52 which are inputted from the input/output unit, the flow rate of dry combustion gas (carbon dioxide) supplied as working fluid to the combustor 20 is calculated. Note that the flow rate of dry combustion gas (carbon dioxide) can also be calculated based on output signals from the flow rate detecting unit 51 and the flow rate detecting unit 52.

Here, the flow rate of dry combustion gas (carbon dioxide) supplied as working fluid is determined as described above based on, for example, the flow rate of fuel supplied to the combustor 20 and the flow rate of carbon dioxide flowing through the pipe 41. For example, the amount equivalent to the amount of carbon dioxide generated by combusting fuel in the combustor 20 is exhausted to the outside via the end of the pipe 40 functioning as an exhaust pipe. In this manner, when the flow rate of fuel is constant for example, the flow rate of carbon dioxide supplied to the entire combustor 20 is controlled to be constant. That is, when the flow rate of fuel is constant, carbon dioxide circulates at a constant flow rate in the system.

Subsequently, the control unit 60 outputs an output signal for regulating the valve opening from the input/output unit to the flow rate regulating valve 29 so that the calculated flow rate of carbon dioxide flows into the pipe 45, based on an output signal from the flow rate detecting unit 53 which is inputted from the input/output unit.

By controlling as described above, the mixed gas constituted of oxygen and dry combustion gas (carbon dioxide), the fuel, and the dry combustion gas (carbon dioxide) as working fluid are supplied to the combustor 20. By performing such control, for example, even when a load variation or the like occurs, the flow rate of carbon dioxide supplied to the combustor 20 is made constant while the mass ratio of oxygen in the mixed gas is made constant.

As described above, in the gas turbine facility 10 of the embodiment, a part of combustion gas (dry combustion gas) from which water vapor is removed is mixed with oxidant and supplied to the combustor 20, the combustion gas temperature decreases. Thus, in the combustor 20, the amount of generated carbon monoxide generated by thermal dissociation of carbon dioxide is suppressed, and the concentration of carbon monoxide decreases. Further, by mixing the dry combustion gas (carbon dioxide) with the oxidant (oxygen), the oxidation of the pipes is suppressed.

In the embodiment as described above, the oxidation of supply pipes of oxidant is suppressed, and the concentration of exhausted carbon monoxide decreases.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1.-6. (canceled)

7. A process for operation of a power generation plant, the process comprising:
providing a fuel flow rate detecting unit output signal, an oxygen flow rate detecting unit output signal, and at least one carbon dioxide flow rate detecting unit output signal to a control unit;
calculating in the control unit, based upon the output signals received from one or more of the fuel flow rate detecting unit, the oxygen flow rate detecting unit, and the at least one carbon dioxide flow rate detecting unit, at least one of a required fuel flow rate, a required oxygen flow rate, and a required carbon dioxide flow rate;
regulating flow of at least one of a fuel stream, an oxygen stream, and a carbon dioxide stream through a corresponding fuel flow regulating valve, oxygen flow regulating valve, and carbon dioxide flow regulating valve, respectively, so that one or more of the fuel stream, the oxygen stream, and the carbon dioxide stream is supplied in required amounts;
combusting fuel from the fuel stream with the oxygen from the oxygen stream in the combustor in the presence of the carbon dioxide from the carbon dioxide stream to form a combustion exhaust gas; and
passing the combustion exhaust gas through a turbine to generate power.

8. The process of claim 7, comprising regulating flow of the fuel stream through the fuel flow regulating valve based upon a required output of the turbine.

9. The process of claim 7, comprising regulating flow of the fuel stream through the fuel flow regulating valve and regulating flow of the oxygen through the oxygen flow regulating valve so that the fuel from the fuel stream and the oxygen from the oxygen stream are supplied to the combustor in a desired ratio.

10. The process of claim 8, wherein the fuel from the fuel stream and the oxygen from the oxygen stream are supplied to the combustor in approximately a stoichiometric mixture ratio.

11. The process of claim 7, further comprising mixing carbon dioxide from the carbon dioxide stream with the oxygen in the oxygen stream prior to combusting the fuel from the fuel stream with the oxygen from the oxygen stream in the combustor.

12. The process of claim 11, comprising regulating flow of the carbon dioxide through a first carbon dioxide regulating valve and regulating flow of the oxygen through the oxygen flow regulating valve so that the oxygen stream input to the combustor comprises carbon dioxide and oxygen in a desired mass percentage ratio.

13. The process of claim 12, wherein the flow of the carbon dioxide through the first carbon dioxide regulating valve and the flow of the oxygen through the oxygen flow regulating valve are regulated so that the oxygen stream input to the combustor comprises carbon dioxide and comprises 15% to 40% by mass oxygen.

14. The process of claim 7, comprising regulating flow of the carbon dioxide through a second carbon dioxide regulating valve so that a desired flow of carbon dioxide working fluid is input to the combustor.

15. The process of claim 14, comprising regulating the flow of the carbon dioxide through the second carbon dioxide regulating valve based upon output signals received from the fuel flow rate detecting unit and a carbon dioxide flow rate detecting unit.

16. The process of claim 14, comprising regulating the flow of the carbon dioxide through the second carbon dioxide regulating valve based upon output signals received from the oxygen flow rate detecting unit and a carbon dioxide flow rate detecting unit.

17. The process of claim 14, wherein the control unit is configured to regulate flow of the carbon dioxide through the second carbon dioxide regulating valve based at least upon an output received from a carbon dioxide flow rate detecting unit.

18. The process of claim 7, wherein the control unit is configured to control an amount of carbon dioxide supplied to the combustor from the carbon dioxide stream to be substantially constant.

19. The process of claim 7, further comprising cooling an exhaust gas from the turbine in a heat exchanger.

20. The process of claim 19, further comprising removing water vapor from a cooled exhaust stream from the heat exchanger using a water vapor condenser to provide the carbon dioxide stream.

21. The process of claim 20, further comprising separating the carbon dioxide stream into a first carbon dioxide stream and a second carbon dioxide stream.

22. The process of claim 21, further comprising compressing the first carbon dioxide stream.

23. The process of claim 21, further comprising guiding the second carbon dioxide stream for mixing with the oxygen stream.

24. A process for operation of a power generation plant, the process comprising:
providing a fuel stream, an oxygen stream, and a carbon dioxide working fluid stream to a combustor wherein fuel from the fuel stream is combusted with oxygen from the oxygen stream in the presence of the carbon dioxide working fluid stream to form a combustion exhaust stream;
rotating a turbine with the combustion exhaust stream to generate power and provide a turbine exhaust stream;
cooling the turbine exhaust stream in a heat exchanger to form a cooled turbine exhaust stream;
removing water from the cooled turbine exhaust stream to form the carbon dioxide working fluid stream;
separating the carbon dioxide working fluid stream into a first carbon dioxide working fluid stream and a second carbon dioxide working fluid stream;
compressing the second carbon dioxide working fluid stream;
recycling the second carbon dioxide working fluid stream to the combustor;
mixing the first carbon dioxide working fluid stream into the oxygen stream upstream from the combustor;
providing an output signal from a fuel flow rate detecting unit, an output signal from an oxygen flow rate detecting unit output signal, and an output signal from at least one carbon dioxide flow rate detecting unit to a control unit;
calculating in the control unit, based upon the received output signals, at least one of a required fuel flow rate, a required oxygen flow rate, and a required carbon dioxide flow rate; and
regulating flow of at least one of the fuel stream, the oxygen stream, the first carbon dioxide working fluid stream, and the second carbon dioxide working fluid stream through a corresponding fuel flow regulating valve, oxygen flow regulating valve, first carbon dioxide working fluid flow regulating valve, and second carbon dioxide working fluid flow regulating valve, respectively, so that one or more of the fuel stream, the oxygen stream, the first carbon dioxide working fluid stream, and the second carbon dioxide working fluid stream is supplied in required amounts.

25. The process of claim 24, wherein the first carbon dioxide working fluid stream is mixed into the oxygen stream in an amount so that the oxygen stream provided to the combustor comprises carbon dioxide and comprises 15% to 40% by mass oxygen.
